(19) United States
(12) Patent Application Publication
(10) Pub. No.: US 2008/0136592 A1
(43) Pub. Date: Jun. 12, 2008

(54) RFID-BASED REMINDER SERVICE

(75) Inventors: Ajay MALIK, San Jose, CA (US); Puneet BATTA, Santa Clara, CA (US)

Correspondence Address: INGRASSIA FISHER & LORENZ, P.C., 7010 E. COCHISE ROAD, SCOTTSDALE, AZ, 85253, US

(73) Assignee: SYMBOL TECHNOLOGIES, INC., Holtsville, NY (US)

(21) Appl. No.: 11/567,778

(22) Filed: Dec. 7, 2006

(51) Int. Cl. H04Q 5/22

(52) U.S. Cl. 340/10.1

(57) ABSTRACT

An RFID-based reminder system as described herein leverages RFID technology to manage deadline-driven items of correspondence such as bills, event invitations, meeting notices, voting ballots, jury duty notices, and the like. RFID tags are affixed to (or embedded into) items of correspondence, and the tags are programmed with relevant data such as a response deadline, the action to be taken, and the name of the originating company or entity. Upon receipt, the recipient can interrogate the correspondence using an RFID reader, and the received RFID tag data is processed by one or more software applications running on a computing device of the recipient. The computing device can then automatically generate event reminders that notify the user of approaching response deadlines for the items of correspondence.

### TECHNICAL FIELD

Embodiments of the present invention relate generally to radio frequency identification (RFID) systems. More particularly, embodiments of the present invention relate to an RFID-based reminder service for correspondence such as bills, event invitations, and invoices.

### BACKGROUND

People often receive paper correspondence, such as bills, invoices, event invitations, and meeting notices, that might have one or more important dates associated therewith. For example, a bill usually has a specific payment deadline, an event invitation will designate the time and date of the event (and possibly an RSVP deadline), and a meeting notice will designate the time and date of the meeting. When pressed for time, people typically collect such correspondence in one or more locations for follow up at a later time. Unfortunately, stockpiling of deadline-driven correspondence in this manner can result in missed deadlines or delinquent payment of bills. Even if an electronic organizer or calendar application is available, the stockpiling of deadline-driven correspondence can be problematic without a quick and easy way to determine whether a certain piece of correspondence requires immediate attention.

RFID systems are well known and the prior art is replete with different types of RFID systems, different applications for RFID systems, and different data communication protocols for RFID systems. Briefly, an RFID system includes two primary components: a reader (also known as an interrogator); and a tag (also known as a transponder). The tag is a miniature device that is capable of responding, via an air channel, to a radio frequency (RF) signal generated by the reader. The tag is configured to generate a reflected RF signal in response to the RF signal emitted from the reader. The reflected RF signal is modulated in a manner that conveys identification data back to the reader.

There currently exist no RFID-based reminder systems that enable deadline-driven correspondence to be managed and sorted in a quick and automated manner. Furthermore, there currently exist no RFID-based reminder systems that automatically generate deadline reminders for deadline-driven correspondence.

### BRIEF SUMMARY

The techniques and technologies described herein provide an RFID-based reminder service for deadline-driven correspondence received by a user. The RFID tag data can be managed by a suitably configured calendar/reminder application resident at a computing device. When necessary, the calendar/reminder application can generate an event reminder and/or initiate a reminder action for the deadline-driven correspondence.

The above and other aspects may be carried out in one embodiment by a method for providing a reminder service to a user. The method involves: performing RFID interrogation on an item of correspondence; obtaining RFID tag data in response to the RFID interrogation, the RFID tag data comprising deadline data that indicates a response deadline associated with the item of correspondence; and processing the deadline data with a reminder application.

The above and other aspects may be carried out in one embodiment by a system for providing a reminder service to a user. The system includes: an RFID reader configured to perform RFID interrogation on an item of correspondence; a computing device configured to communicate with the RFID reader to obtain RFID tag data in response to the RFID interrogation, the RFID tag data comprising deadline data that indicates a response deadline associated with the item of correspondence; and a reminder application executed by the computing device, the reminder application being configured to initiate a reminder action in response to the deadline data.

The above and other aspects may be carried out in one embodiment by a method for providing a reminder service to a user. The method involves: receiving RFID tag data that originates from an item of correspondence; extracting deadline data from the RFID tag data, the deadline data indicating a response deadline associated with the item of correspondence; calendaring the deadline data with an electronic calendar application; and the electronic calendar application initiating a reminder action for the response deadline.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a schematic representation of an embodiment of an RFID-based reminder system;

FIG. 2 is a front view of an item of correspondence having an RFID tag;

FIG. 3 is a schematic representation of an embodiment of a computing device suitable for use with the system shown in FIG. 1;

FIG. 4 is a flow chart that illustrates an embodiment of an RFID-based reminder process; and

FIG. 5 is a schematic representation of RFID tag data suitable for use with a deadline-driven item of correspondence.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of data transmission protocols and that the system described herein is merely one example embodiment of the invention.

For the sake of brevity, conventional techniques related to RFID data transmission, RFID system architectures, computing device architectures, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

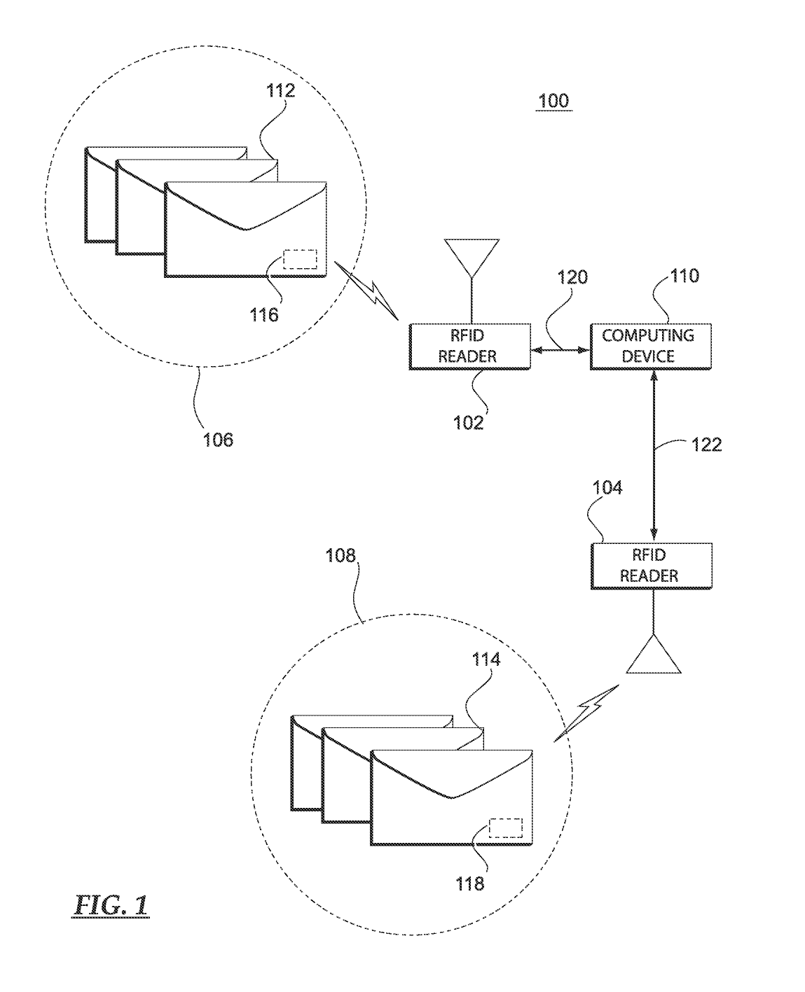

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 1 depicts one example arrangement of elements, additional intervening elements, devices, features, or components may be present in an embodiment of the invention.

Briefly, the techniques and technologies described herein leverages the use of RFID tags with paper correspondence such as utility bills, event invitations, invoices, or the like. A user may use an off-the-shelf RFID reader that is operatively coupled to a personal computer (PC) running one or more suitably configured software applications. The RFID reader reads the tag data by interrogating the correspondence. If an application on the PC determines that a response deadline is approaching for a given item of correspondence, it can initiate an appropriate reminder action to remind the user of the approaching deadline. The PC may employ email, telephone, electronic messaging, and/or other techniques and technologies to convey the reminder to the user.

FIG. 1 is a schematic representation of an embodiment of an RFID-based reminder system 100, which includes RFID readers 102/104. Although FIG. 1 depicts only two RFID readers, an actual deployment of system 100 may include any number of RFID readers. Alternatively, an embodiment of system 100 may include only one RFID reader. In this example, RFID reader 102 services a first read zone 106, while RFID reader 104 services a second read zone 108. A given read zone may represent any arbitrary area or physical feature within the system environment, including, without limitation: a cabinet; a room; a desk drawer; an office cubicle; or the like. In practical deployments, the read zones 106/108 may be distinct or they may overlap with each other. System 100 also includes a computing device 110 that cooperates with RFID readers 102/104.

RFID readers 102/104 are each configured to perform RFID interrogation on one or more items of correspondence located in the system environment. FIG. 1 depicts an environment where some items of correspondence 112 are located in read zone 106, while other items of correspondence 114 are located in read zone 108. RFID readers 102/104 may be configured to operate in a conventional manner to interrogate RFID tags 116/118 associated with correspondence 112/114, to read RFID tag data generated by RFID tags 116/118, and to send the RFID tag data (arranged in an appropriate format) to computing device 110. In certain embodiments, RFID readers 102/104 are also configured to program RFID tag data into RFID tags 116/118.

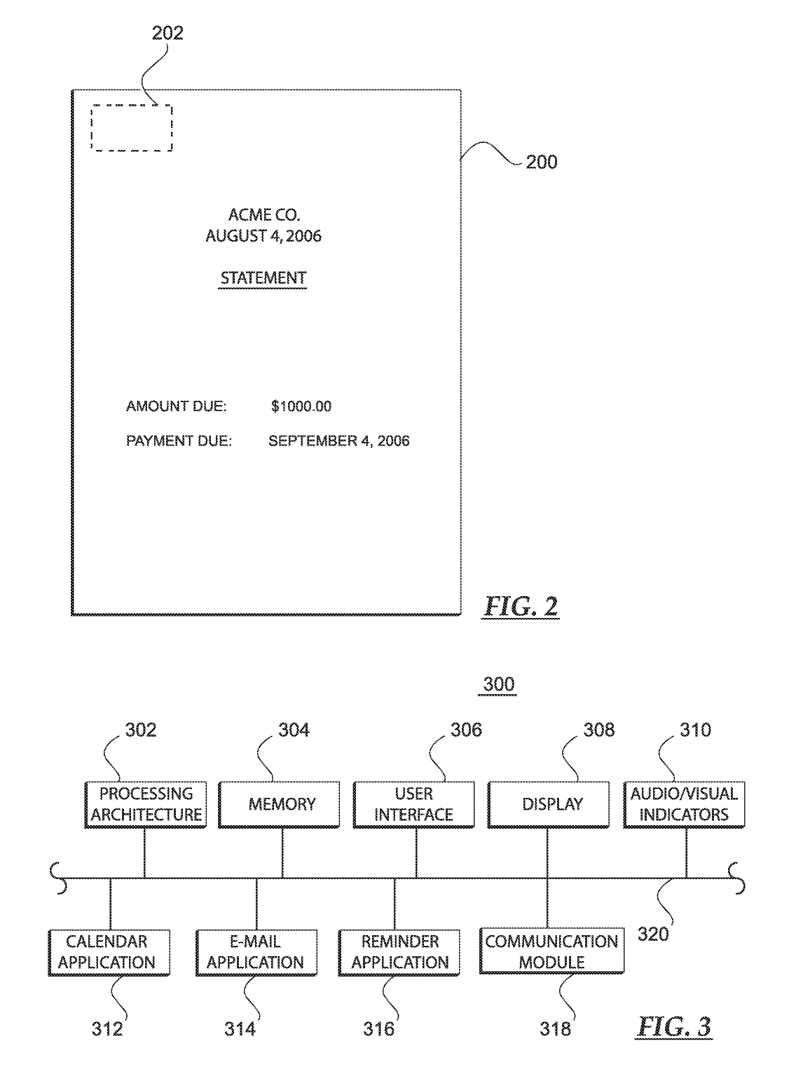

RFID tags 116/118 may be affixed to the items of correspondence 112/114 or inserted into envelopes that carry the items of correspondence 112/114. In this regard, FIG. 2 is a front view of an item of correspondence 200 having an RFID tag 202 affixed thereto. RFID tag 202 can be located anywhere on correspondence 200; FIG. 2 merely depicts one example where RFID tag 202 is located at a corner of the page. RFID tag 202 may be realized using known techniques and technologies, which need not be described in detail herein.

In one embodiment, RFID tag 202 is printed onto the item of correspondence 200. In this regard, RFID tag 202 can be printed onto correspondence 200 concurrently with the printing of the desired text information. Alternatively, RFID tag 202 can be printed onto the page during a separate printing operation. In another embodiment, RFID tag 202 is embedded in (or otherwise attached to) the correspondence 200. For example, it may be possible to embed or attach RFID tag 202 during production of the blank paper page. Alternatively, RFID tag 202 can be embedded or attached to the blank paper page as a separate operation, which may occur before or after printing of the text information.

Referring back to FIG. 1, RFID-based reminder system 100 also includes a suitably configured computing device 110, which is operatively coupled to RFID readers 102/104 in a manner that supports data communication from RFID readers 102/104 to computing device 110 (and, in certain embodiments, data communication from computing device 110 to RFID readers 102/104). For this example, computing device 110 is configured to communicate with RFID readers 102/104, via data communication links 120/122, to obtain the RFID tag data generated by RFID tags 116/118. A data communication link 120/122 may be unidirectional or bidirectional, and wired or wireless. For example, a data communication link 120/122 may include, without limitation: a USB cable; an IEEE-1394 cable; an infrared link; an IEEE-802.11 link; a BLUETOOTH wireless data link; or the like.

Computing device 110 may be realized using any desired form factor, including, without limitation: a PC; a laptop PC; a personal digital assistant (PDA); a mobile telephone; a digital media player; or the like. Computing device 110 may include one or more software applications that it executes to support the operation of RFID-based reminder system 100. For example, computing device 110 may process or manage the RFID tag data with a suitably configured calendar application and/or a suitably configured reminder application. In certain embodiments of system 100, these applications may cooperate with one or more other applications resident at computing device 110, including, without limitation: an email application; an instant messaging application; a pager messaging application; a text messaging application; a facsimile application; a document management application; a printer driver; a telephone or telecommunication application; a display driver; an audio/visual indicator driver; or the like.

FIG. 3 is a schematic representation of an embodiment of a computing device 300 suitable for use with RFID-based reminder system 100. Computing device 300 generally includes, without limitation: a processing architecture 302; a suitable amount of memory 304; a user interface 306; a display 308; audio and/or visual indicators 310; a calendar application 312; an email application 314; a reminder application 316; and a communication module 318. Some or all of these elements may be coupled together with a bus 320 or any suitable interconnection arrangement or architecture. An embodiment of computing device 300 may include additional elements, components, features, and/or functionality associated with conventional operating aspects, and such conventional aspects will not be described in detail herein.

Processing architecture 302 may be realized with any number of hardware, software, and/or firmware components, and processing architecture 302 may include any number of logical or functional modules. Processing architecture 302 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor may be realized as a microprocessor, a controller, a microcontroller, or a state machine. Moreover, a processor may be implemented as a combination of computing devices, e.g., a combination of a digital signal processor and a microprocessor, a plurality of microprocessors, one or more microprocessors in conjunction with a digital signal processor core, or any other such configuration.

In practice, processing architecture 302 may be suitably configured to perform and/or support the various operations, features, techniques, functions, and operations described herein. In this example, processing architecture 302 manages and controls the operation of calendar application 312, email application 314, reminder application 316, and communication module 318. Moreover, processing architecture 302 may manage and control the operation of display 308 and audio/visual indicators 310. Moreover, although FIG. 3 depicts certain elements as distinct blocks or modules, processing architecture 302 may include or incorporate additional functional components (or portions thereof) of computing device 300, such as communication module 318.

Memory 304 may be realized as RAM memory, flash memory, EPROM memory, EEPROM memory, registers, a hard disk, a removable disk, a CD-ROM, or any other form of storage medium known in the art. In this regard, memory 304 can be coupled to processing architecture 302 such that processing architecture 302 can read information from, and write information to, memory 304. In the alternative, memory 304 may be integral to processing architecture 302. As an example, processing architecture 302 and memory 304 may reside in an ASIC. In this example, memory 304 may be utilized to store RFID tag data (or portions thereof) as needed to support the operation of the RFID-based reminder system, and to store other information that may relate to conventional operating features of computing device 300.

When implemented in software or firmware, various elements of the systems described herein (which may reside at computing device 300) are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, an RF link, or the like.

User interface 306 may include any number of features that enable a user to interact with computing device 300. User interface 306 may include, without limitation: a keyboard; a mouse or other pointing device; a touch screen or a touchpad; buttons; switches; or the like. Display 308 enables computing device 300 to generate images, graphics, and other visual indicia for the user. Display 308 may be integrated with the main housing of computing device (e.g., for a PDA or a mobile telephone) or it may be a separate component (e.g., for a desktop PC). The specific size, configuration, and feature set of user interface 306 and display 308 will depend upon the form factor of computing device 300.

Audio/visual indicators 310 may be utilized to provide reminder notifications to the user. For example, computing device 300 may include one or more speakers or sound transducers that are driven by reminder application 316 when necessary to generate an audible alert. Additionally or alternatively, computing device 300 may include one or more lights, electromechanical flags, or display elements (e.g., display 308) that are driven by reminder application 316 when necessary to generate a visible notification. The format and content of the audio/visual message may be simple or complex depending upon the particular implementation. For example, an audio message may be a simple alarm tone or a recorded voice message. As another example, a visual message may be a simple illuminated LED light or a graphically displayed text message.

Calendar application 312 is an electronic computer-executable software application, which preferably resides at computing device 300. Calendar application 312 provides conventional calendaring, appointment scheduling, reminder notification, and other common features. For this example, calendar application 312 is configured to maintain deadline data obtained from RFID tags affixed to (or embedded in) items of correspondence. Calendar application 312 may be incorporated into a larger application having additional functionality, it may be included in a suite of related software applications, or it may be configured as an application plug-in for an off-the-shelf or existing software application. As one non-limiting example, calendar application 312 may be suitably configured for compatible operation with the Outlook brand software application by Microsoft Corporation, or the web-based calendar applications provided by Yahoo and Google.

Email application 314 is an electronic computer-executable software application, which preferable resides at computing device 300. Email application 314 provides conventional email authoring, sending, receiving, and management functions for computer device 300. Email application 314 may be incorporated into a larger application having additional functionality, it may be included in a suite of related software applications, or it may be configured as an application plug-in for an off-the-shelf or existing software application. As one non-limiting example, email application 314 may be suitably configured for compatible operation with the Outlook brand software application by Microsoft Corporation, or the web-based email applications provided by Yahoo and Google.

Reminder application 316 is an electronic computer-executable software application, which preferable resides at computing device 300. Reminder application 316 is suitably configured to process RFID tag data received from RFID readers 102/104 (see FIG. 1). In particular, reminder application 316 can process deadline data that indicates response deadlines associated with certain items of correspondence. Moreover, reminder application 316 can initiate reminder actions (when necessary) in response to deadline data. As described in more detail below, such reminder actions include, without limitation: electronic message generation; facsimile document generation; printed document generation; telephone call initiation; audio indicator triggering; and visual indicator triggering. Conceptually, reminder application 316 serves as an interface between RFID readers 102/104 and other software applications maintained by computing device 300, such as calendar application 312 and email application 314. In practice, reminder application 316 may include calendar application 312 and/or email application 314. Moreover, reminder application 316 may be incorporated into a larger application having additional functionality, it may be included in a suite of related software applications, or it may be configured as an application plug-in for an off-the-shelf or existing software application.

Communication module 318 may represent processing logic that is suitably configured to support the data communication protocols, schemes, and techniques utilized by computing device 300. In practice, communication module 318 or a portion thereof may be considered to be part of processing architecture 302. For simplicity, FIG. 3 depicts one communication module 318. An embodiment of computing device 300, however, may include any number of communication modules. Communication module 318 is generally configured to: receive RFID data from RFID readers 102/104; communicate data with peripheral devices; communicate data via a data communication network; etc. In certain embodiments, communication module 318 may also be configured to transmit data to RFID readers 102/104. In connection with RFID-based reminder system 100, communication module 318 may be configured to support one or more of the following data communication methodologies, without limitation: electronic messaging (such as email, pager messaging, instant messaging, text messaging); facsimile document transmission; telecommunication; and document printing. Any of these data communication methodologies can be utilized to convey event reminders, alarms, deadline notifications, or other content to a user of system 100.

For wireless communication of data, communication module 318 may support any number of suitable wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. Computing device 300 may include one or more interfaces that cooperate with communication module 318 to support wireless data communication with other devices. For example, computing device 300 may include an RF radio, an infrared transceiver device, or the like.

For communication of data over a cable, a wired connection, or other physical link, communication module 318 may support any number of suitable data communication protocols, techniques, or methodologies, including, without limitation: Ethernet; home network communication protocols; USB; IEEE 1394 (Firewire); hospital network communication protocols; and proprietary data communication protocols. Computing device 300 may include one or more interfaces that cooperate with communication module 318 to support data communication with other devices using a tangible link, e.g., a cable, a wired connection, or a mechanical connection such as a docking port, a plug, a contact element, a connector, a jack, a receptacle, a socket, an adaptor, or the like.

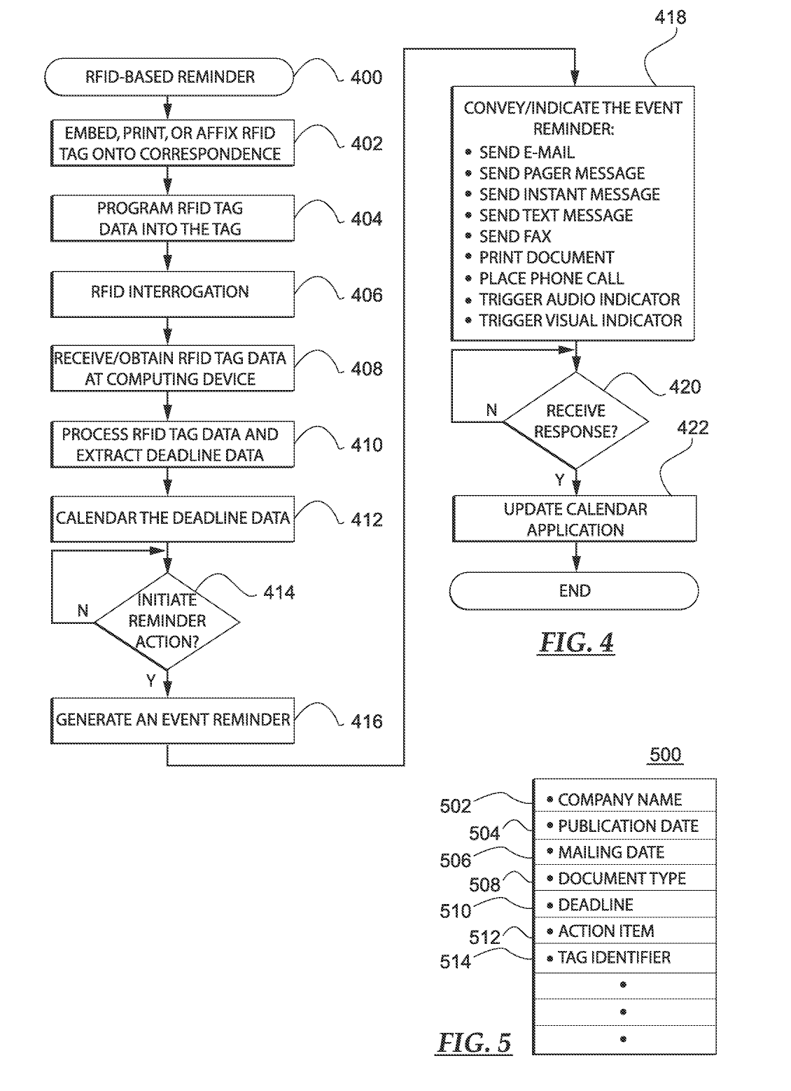

FIG. 4 is a flow chart that illustrates an embodiment of an RFID-based reminder process 400, which may be performed by RFID-based reminder system 100. The various tasks performed in connection with process 400 may be performed by software, hardware, firmware, or any combination thereof. For illustrative purposes, the following description of process 400 may refer to elements mentioned above in connection with FIGS. 1-3. In embodiments of the invention, portions of process 400 may be performed by different elements of the described system, e.g., an RFID reader or a computing device that is coupled to an RFID reader. It should be appreciated that process 400 may include any number of additional or alternative tasks, the tasks shown in FIG. 4 need not be performed in the illustrated order, and process 400 may be incorporated into a more comprehensive procedure or process having additional functionality not described in detail herein.

RFID-based reminder process 400 assumes that the user has already configured and initialized a system such as RFID-based reminder system 100. Although not necessary, it may be desirable to have reminder application 316 running before process 400 begins (if reminder application 316 is already running, then the RFID readers can store unreported event data and communicate the stored data upon establishing connectivity with the computing device). For multizone embodiments, the user can manipulate reminder application 316 to configure the different read zones for the different RFID readers. For example, the user can set the range of each RFID reader to define each read zone. In practice, the range of an RFID reader in system 100 will typically be between one inch and twenty feet. Configuring the read zones enables the system to determine the range at which RFID tags can be read, contemplate the number and/or type of antennas used by the RFID readers, or the like. System 100 may also be set to only interrogate RFID tags on demand (i.e., when instructed to do so by the user) or to interrogate RFID tags in response to the detection of movement in close proximity to the RFID readers. Such movement detection may be utilized to trigger RFID interrogation when the user waves an item of correspondence near an RFID reader.

RFID-based reminder process 400 may begin by embedding, printing, or affixing an RFID tag onto an item of correspondence (task 402) and/or by programming RFID tag data into the RFID tag (task 404). After completion of tasks 402 and 404, the correspondence will include an RFID tag that has been programmed with RFID tag data.

In one embodiment, task 402 is performed by the sender/originator of the correspondence. For example, task 402 may be performed at a mailing facility of a company during an invoice or bill generation operation. In another embodiment, task 402 is performed by the recipient of the correspondence. In such an embodiment, the items of correspondence need not be modified or treated in any special manner. Rather, the user of the RFID-based reminder system provides the RFID tags to be used with RFID-based reminder process 400.

Regarding task 402, the RFID tag may be affixed to the item of correspondence using an adhesive, tape, or any suitable fastening technique. Alternatively, the RFID tag may be printed onto the item of correspondence using an enhanced printer device. As mentioned above, the printed text of the correspondence may be concurrently printed while the RFID tag is being printed. Alternatively, the RFID tag may be embedded into the paper or substrate used for the item of correspondence (this operation may be performed by the manufacturer of the paper or substrate). In lieu of attaching, affixing, or embedding the RFID tag onto the item of correspondence, the RFID tag may be attached, affixed, or embedded onto the envelope to be used for the item of correspondence. Alternatively, the RFID tag may simply be placed into the envelope prior to sealing.

The programming of the RFID tag (task 404) may be performed by the sender/originator of the correspondence and/or by the recipient of the correspondence. A suitably configured RFID compatible device, such as RFID readers 102/104, may be utilized to program the RFID tag data into the RFID tag. RFID tag programming techniques and technologies are known to those skilled in the art, and, therefore, such techniques and technologies need not be described in detail here. The sender/originator may choose to program the RFID tag at or near the time of printing (indeed, the programming may occur concurrently with the printing of the correspondence). If the recipient is responsible for programming, task 404 may be performed at any time after receipt of the correspondence. As mentioned above, the user can make use of an RFID tag that is already embedded or affixed to the correspondence or envelope, or the user can embed or affix a new RFID tag to the item of correspondence or envelope at any convenient time.

FIG. 5 is a schematic representation of RFID tag data 500 suitable for use with a deadline-driven item of correspondence. RFID tag data 500 represents the data that is programmed into RFID tags utilized with the RFID-based reminder system described herein. RFID tag data 500 may be encrypted or hashed using an irreversible algorithm that is based upon a secret user code, identifier, or string. Moreover, the formatting of RFID tag data 500 may be proprietary to the particular software application that handles the RFID tag data 500. For example, RFID tag data 500 may be suitably formatted for proprietary compatibility with reminder application 316 (see FIG. 3). This feature provides enhanced security for the system.

In practice, the software application utilized by the RFID-based reminder system may allow the tag programmer to select the types of data fields programmed into the RFID tag. In addition, the RFID tag may have one or more default fields that represent commonly used data types for this application. For example, RFID tag data 500 may include, without limitation, data indicative of the following items: the originating company/entity name 502; the publication or statement date 504; the mailing date 506; the document type 508 (e.g., a bill, an invitation, a jury duty notice, a product recall notice, a proxy voting statement, etc.); deadline data 510 that indicates a response deadline associated with the item of correspondence; an action item 512 associated with the correspondence (e.g., bill payment, RSVP, vote, meeting attendance, etc.); and a tag identifier 514, which may be a globally unique identifier, an identifier that is locally unique within the RFID-based reminder system, or an identifier that is locally unique for the originating company/entity. The ellipses in FIG. 5 indicate that RFID tag data 500 may include any number of additional or alternative data fields; those shown in FIG. 5 are not intended to limit or otherwise restrict the scope or uses of the embodiments described herein.

Referring back to FIG. 4, the recipient can now perform RFID interrogation (task 406) on the item of correspondence. The RFID interrogation may be performed by any number of RFID readers for any number of read zones. The interrogation can be triggered in any suitable manner, depending upon the particular system implementation and user preferences. For example, interrogation may be performed automatically and periodically in accordance with a predetermined schedule, or it may be performed in response to the detection of movement (using suitably configured motion sensors) within a read zone or near an RFID reader. As another example, the user may initiate the RFID interrogation using a physical switch or button located at an RFID reader and/or using a software application that manages the RFID readers.

In some embodiments, RFID interrogation is performed on an item-by-item basis, which allows the RFID-based reminder system to determine whether or not a given item of correspondence includes a compatible RFID tag. Accordingly, the system and the reminder application on the computing device may be suitably configured to manage traditional forms of correspondence that are void of RFID tags. In such an embodiment, the software may be configured to indicate to the user whether or not an item of correspondence contains an RFID tag.

In response to the RFID interrogation, an RFID reader may receive RFID tag data that is generated by an RFID tag of an item of correspondence. Next, the RFID reader sends the RFID tag data—or reformatted data that conveys the RFID tag data—to the computing device, which receives and obtains the RFID tag data (task 408). The system may be configured to determine whether or not an RFID tag is programmed. Accordingly, task 408 may receive RFID tag data that conveys no content other than overhead information. In that situation, the system may query the user to determine whether or not the user intends to program the RFID tag before storing or filing the item of correspondence.

The system can process the received RFID tag data (task 410) in an appropriate manner and in accordance with the system requirements and the user preferences. For example, the system may give the user the option to “kill” a tag, i.e., remove the data from an RFID tag that is affixed to an item of correspondence. This option may be selected if, for example, the user decides to ignore or discard the item of correspondence. This option may also result in the deletion of the associated RFID tag data from the computing device and/or the supporting software applications.

During task 410, the computing device may extract and store relevant information from the received RFID tag data. For example, the computing device may extract deadline data and/or any of the data types described above for RFID tag data 500. Such data extraction may be desirable to enable the supporting software applications to efficiently handle the relevant items of the RFID tag data. In this embodiment, the computing device processes the deadline data for compatibility with a reminder application and/or a calendar application. Thus, the deadline data can be calendared (task 412) using the calendar application. For example, the deadline data can be entered along with a reminder date/time that indicates when a reminder will be generated. In addition, the deadline data can be entered along with one or more selected reminder types or modes, which represent the manner in which the system will remind the user.

The electronic calendar application may be suitably configured to initiate a reminder action for the response deadline, where the reminder action is triggered by the deadline data and/or any reminder options associated with the deadline data. Therefore, if RFID-based reminder process 400 determines that it is time to initiate a reminder action (query task 414), then the system generates an appropriate event reminder (task 416) for the given response deadline. As used herein, an “event reminder” is any notification, message, or user-detectable phenomena that indicates a deadline or an approaching deadline. In one preferred embodiment, event reminders are generated automatically by the computing device.

Eventually, the system will convey and/or indicate the event reminder (task 418) using one or more techniques or technologies. For example, the computing device may send an electronic message that conveys the event reminder, where the electronic message may be, without limitation: an email; a pager message; an instant message; a text message; a ring tone; a voice message; a notification intended for a home entertainment device such as a television, a cable box, a digital video recorder, or an audio system; or a notification intended for a vehicle subsystem or application such as a GPS system, a navigation system, or an onboard emergency communication service; or the like. The electronic message may include any of the RFID tag data types described herein, such as the deadline date and the required action item. As another example, the computing device may be configured to generate and send a facsimile document that conveys the event reminder, and/or to generate and print a document that conveys the event reminder. As yet another example, the computing device may be configured to initiate a telephone call to a designated phone number, where the telephone call functions to convey the event reminder. In this regard, the system may generate a computer-generated voice message that provides an audio reminder via the phone call. In practice, the computing device may be configured to support VoIP or an equivalent telecommunication protocol to support an auto-dialing feature. Of course, the computing device may need to employ suitably configured document management, printer driver, telecommunication, and other related applications to support these functions.

The computing device may also be configured to generate “local” reminder indicators that need not rely on data communication with external components. For example, task 418 may trigger an audio indicator that is played from a speaker of the computing device. The audio indicator conveys the event reminder in any desired format (a simple tone, an alarm, a computer-generated voice message, etc.). As another example, task 418 may trigger a visual indicator that is produced from a component of the computing device such as an LED light, the main display element, or an electromechanical device driven by the computing device. The visual indicator conveys the event reminder in any desired format (a flashing light, a text message, a graphic image, etc.). Of course, the computing device may need to employ suitably configured device drivers to support these functions.

RFID-based reminder process 400 may accommodate user responses or replies to event reminders. If process 400 receives a suitably formatted response to an event reminder (query task 420), then it may update the calendar application, the reminder application, and/or other applications as necessary (task 422). For example, if the user responds to an event reminder with an “OK” instruction, then the computing device will generate no further event reminders. On the other hand, if the user responds with a “SNOOZE” instruction, then the computing device will generate a follow up event reminder for the same deadline. As another example, the user may respond to an event reminder with a “DELETE” instruction to remove the scheduled event from the calendar application. Of course, other types of user responses and replies may be contemplated by an embodiment of process 400.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes known equivalents and foreseeable equivalents at the time of filing this patent application.

What is claimed is:

1. A method for providing a reminder service to a user, the method comprising:
performing RFID interrogation on an item of correspondence;
obtaining RFID tag data in response to the RFID interrogation, the RFID tag data comprising deadline data that indicates a response deadline associated with the item of correspondence; and
processing the deadline data with a reminder application.

2. A method according to claim 1, further comprising programming the RFID tag data into an RFID tag of the item of correspondence.

3. A method according to claim 2, further comprising affixing the RFID tag to the item of correspondence.

4. A method according to claim 3, wherein affixing the RFID tag comprises printing the RFID tag onto the item of correspondence.

5. A method according to claim 3, wherein affixing the RFID tag comprises embedding the RFID tag into the item of correspondence.

6. A method according to claim 1, wherein:
the reminder application includes a calendar application; and
processing the deadline data comprises:
entering the deadline data into the calendar application; and
generating an event reminder for the response deadline.

7. A method according to claim 6, further comprising sending an electronic message that conveys the event reminder.

8. A method according to claim 7, wherein the electronic message is from the group consisting of: an email, a pager message, an instant message, a voice message, a ring tone, and a text message.

9. A method according to claim 6, further comprising sending a facsimile document that conveys the event reminder.

10. A method according to claim 6, further comprising initiating a telephone call that conveys the event reminder.

11. A method according to claim 6, further comprising triggering an audio indicator of the event reminder.

12. A method according to claim 6, further comprising triggering a visual indicator of the event reminder.

13. A method according to claim 6, further comprising printing a document that conveys the event reminder.

14. A system for providing a reminder service to a user, the system comprising:
an RFID reader configured to perform RFID interrogation on an item of correspondence;
a computing device configured to communicate with the RFID reader to obtain RFID tag data in response to the RFID interrogation, the RFID tag data comprising deadline data that indicates a response deadline associated with the item of correspondence; and
a reminder application executed by the computing device, the reminder application being configured to initiate a reminder action in response to the deadline data.

15. A system according to claim 14, the RFID reader being configured to program the RFID tag data into an RFID tag of the item of correspondence.

16. A system according to claim 15, wherein the RFID tag is printed on the item of correspondence.

17. A system according to claim 15, wherein the RFID tag is embedded in the item of correspondence.

18. A system according to claim 14, wherein the reminder application includes a calendar application configured to maintain the deadline data.

19. A system according to claim 14, wherein the reminder action is from the group consisting of: electronic message generation; facsimile document generation; printed document generation; telephone call initiation; audio indicator triggering; and visual indicator triggering.

20. A method for providing a reminder service to a user, the method comprising:
receiving RFID tag data that originates from an item of correspondence;
extracting deadline data from the RFID tag data, the deadline data indicating a response deadline associated with the item of correspondence;
calendaring the deadline data with an electronic calendar application; and
the electronic calendar application initiating a reminder action for the response deadline.

21. A method according to claim 20, further comprising sending, in response to the reminder action, an electronic message that conveys an event reminder for the response deadline.
